(19) United States
(12) Patent Application Publication
(10) Pub. No.: US 2014/0289217 A1
(43) Pub. Date: Sep. 25, 2014

(54) Aggregate Crowdsourcing Systems and Methods

(71) Applicant: Praxol Investments Corp., Jacksonville, FL (US)

(72) Inventor: Donald A. Werkema, Jacksonville, FL (US)

(73) Assignee: PRAXOL INVESTMENTS CORP., Jacksonville, FL (US)

(21) Appl. No.: 14/212,968

(22) Filed: Mar. 14, 2014

Related U.S. Application Data
(60) Provisional application No. 61/800,826, filed on Mar. 15, 2013.

(51) Int. Cl. G06F 17/30

(52) U.S. Cl. CPC G06F 17/30867
USPC 707/710

(57) ABSTRACT

Systems, methods, and computer program products that facilitate aggregation and organization of crowdsource assets and coordinate crowdsourcer access to relevant crowdsource assets are disclosed. In an aspect, the crowdsource assets are aggregated within a pool of crowdsource assets stored in a community network infrastructure and accessible to members of the community network. In another aspect, a crowdsourcer may submit a request to the community network infrastructure for a specific crowdsource asset, and a set of relevant crowdsource assets from the pool may be returned, allowing the crowdsourcer to select the crowdsource asset most compatible with the crowdsourcer.

### CROSS REFERENCE TO RELATED APPLICATION

This application claims the benefit of U.S. Provisional Patent Application No. 61/800,826, filed Mar. 15, 2013, and entitled “System and method to improve crowdsourcing capabilities,” the entire contents of which is incorporated herein by reference.

### FIELD OF THE DISCLOSURE

The present disclosure generally relates to crowdsourcing. More particularly, the present disclosure relates to aggregating crowdsourcing through online communities and websites in order to facilitate creation and growth of businesses.

### BACKGROUND

The statements in this section merely provide background information related to the present disclosure and may not constitute prior art.

Crowdsourcing may be broadly defined as the act of outsourcing tasks to a large group of people or community through an open call. Crowdsourcing has become popular with businesses, non-profit organizations, schools and universities and other entities as a method to leverage the ability of many individuals to provide effective and efficient collaboration as a community through wide-area networks such as, for example, the Internet and web-based technologies. Crowdsourcing may be particularly useful where an entity does not have access to sufficient resources, financial or other, to successfully grow and develop.

Current crowdsourcing systems typically use open calls in order to request solutions or answers to tasks. Generally, an entity that is seeking external resources or a “crowdsourcer” selects and joins the appropriate community (i.e., “crowd”) for the specific task. For example, an open call to identify a graphic artist for a logo design may be posted on one or more of many available websites (e.g., elance.com, 99designs.com, designcrowd.com, etc.).

Crowdsourcing systems typically include a mechanism for the crowdsourcer to provide details describing the task(s) and any other condition or constraint such as, for example, deadlines, non-disclosure agreements, rewards and/or other requirements. Crowdsourced tasks may be performed by anyone in the community including individuals, contractors, formal organizations, consultants and the like. Tasks/questions can be related to product design, business plans, advertising or marketing, funding or any other organizational function. In this way, a crowdsourcing system encourages collaboration, competition, and innovation within the community.

Over the last few years new crowdsourcing platforms have emerged and proliferated. Crowdsourcing has grown from an initial focus on a few very narrow and specific projects or tasks to its current state where a broad diversity of crowdsourcing specialties for almost any organizational function required by an entity may be available through various communities. Crowdsourcing functions currently range from, for example, ideation to product development to marketing and beyond to include, for example, funding, intellectual property protection, and product distribution.

A limitation to the current technology is the narrow scope of existing crowdsourcing web sites as each only offers a small subset of the potentially crowdsourced tasks for any startup or operating organization. Additionally, each new community platform that emerges may have particular strengths and/or weakness in the platform's approach as each focuses on providing narrow, specialized services. Faced with a myriad of possibilities it is difficult to determine which community platform has the appropriate mix of capabilities that can successfully deliver a solution that the crowdsourcer is seeking.

This forces the crowdsourcer to expend significant time and effort identifying individual web sites for each potentially crowdsourced activity. If the crowdsourcer desires several different options for a specific task they will be required to expend additional effort to identify, register with and post their task on multiple communities/websites specializing in the specific task. Finally, the crowdsourcer may not have all the information available to fully understand all of the tasks or resources required to successfully attain their goals and may miss or delay the performance of a critical task. In other words, current technology does not provide an efficient method to fully apply the benefits of crowdsourcing to the crowdsourcer.

Given the foregoing, systems, methods, and computer programs are needed that facilitate access to and organization of more efficient and effective crowdsourcing platforms.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure provide systems, methods, and computer program products that facilitate aggregation and organization of crowdsource assets and provide coordinated access between a crowdsourcer and crowdsource assets. In an aspect, the crowdsource assets may be aggregated within a pool of crowdsource assets stored in a community network infrastructure and accessible to members of the community network. In some aspects, asset contributors may become members of the community network and add to the pool of crowdsource assets. In another aspect, a crowdsourcer may submit a request to the community network infrastructure for a specific crowdsource asset, and a set of relevant crowdsource assets from the pool may be returned, allowing the crowdsourcer to select the crowdsource asset most compatible with the crowdsourcer.

The present disclosure facilitates access to crowdsource assets that may address a broad range of organizational functions may facilitate organizational growth for the crowdsourcer and the asset contributor. In another aspect, potential crowdsource assets may be extracted from crowdsourcer information, which may further encourage collaboration between crowdsourcers and asset contributors. In addition to collaboration, citing potential crowdsource assets may prompt a crowdsourcer to view change or improve their business or project strategy due to viewing it from a different perspective.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating aggregation and organization of crowdsource assets and providing coordinated access between a crowdsourcer and crowdsource assets, according to an aspect of the present disclosure.

FIG. 2 is a data flow diagram of a network system facilitating aggregation and organization of crowdsource assets and providing coordinated access between a crowdsourcer and crowdsource assets, according to an aspect of the present disclosure.

FIG. 3 is a flowchart illustrating an exemplary process for facilitating aggregation and organization of crowdsource assets and providing coordinated access between a crowdsourcer and crowdsource assets, according to an aspect of the present disclosure.

FIG. 4 is a flowchart illustrating an exemplary process for facilitating identification of potential crowdsource assets from a crowdsourcer, according to an aspect of the present disclosure.

FIG. 5 is a flowchart illustrating an exemplary process for facilitating identification of crowdsource assets from asset contributor submitted contributable assets, according to an aspect of the present disclosure.

FIG. 6 is a block diagram of an example computing system useful for implementing the present disclosure.

### DETAILED DESCRIPTION

The present disclosure is directed to systems, methods, and computer program products for facilitating aggregation and organization of crowdsource assets and providing effective crowdsourcer access to the crowdsource assets.

As used herein, crowdsourcer refers to an entity seeking external resources, or “crowdsource assets”, by submitting an open request to a community network. Crowdsource assets may comprise information regarding resources (e.g. providing funding, supplying materials, providing logistical equipment and the like) and solution providers (e.g. accounting services, intellectual property management, logistic coordination, marketing, or other organizational functions) an individual or entity can provide. Crowdsource assets may be defined as a task modified by framing criteria, wherein crowdsource assets may be objectively verified as available.

As used herein, “contributable assets” refer to crowdsource assets volunteered to be contributed by a specific individual or organization (“asset contributor”). In contrast to crowdsource assets, contributable assets may not have been substantiated with objective support that the asset contributor is capable of fulfilling the crowdsource asset. For example, an individual may submit a contributable asset of legal expertise, but to be included as a crowdsource asset, some objective support may be necessary, such as a membership to a state bar or a resume that includes legal experience. Further, “contributable asset portfolio” refers to a set of crowdsource assets that may be contributed a specific individual or organization.

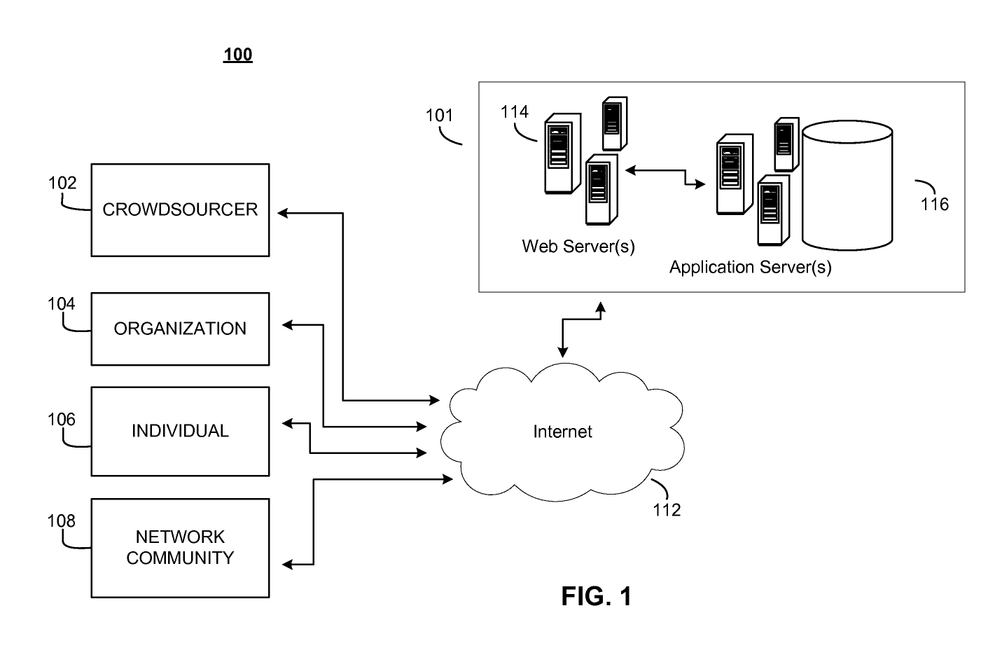

Referring now to FIG. 1, a block diagram of an exemplary system for facilitating aggregation and organization of crowdsource assets and providing coordinated access between a crowdsourcer and crowdsource assets, according to an aspect of the present disclosure, is shown.

Cloud-based, Internet-enabled communication system 100 may include one or more crowdsourcers 102, organizations 104, and individuals 106, accessing—via a computing device and a network 112, such as the global, public Internet—an application service provider's cloud-based, Internet-enabled infrastructure 101. One or more of crowdsourcer 102, organization 104, and individual 106 accesses infrastructure 101 in order to facilitate aggregation and organization of crowdsource assets and providing coordinated access between a crowdsourcer and crowdsource assets in accordance with the present disclosure.

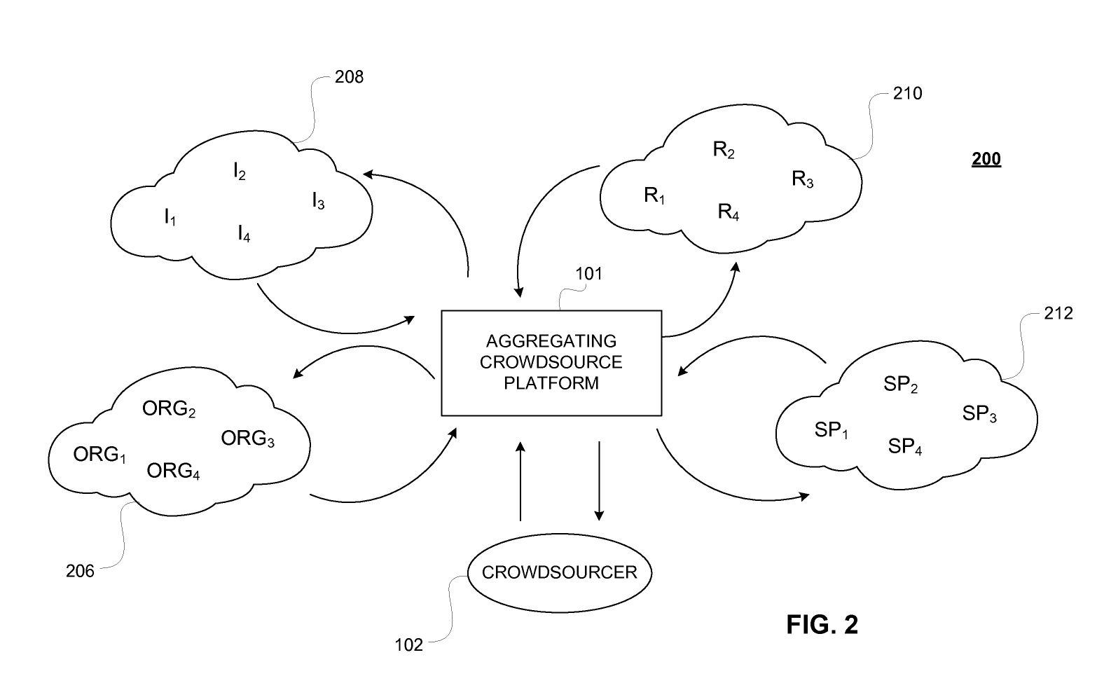

As shown in FIG. 1, in an aspect of the present disclosure, an application service provider's cloud-based, communications infrastructure 101 may include one or more web servers 114 and one or more application servers 116. In some aspects, infrastructure 101 is an aggregating crowdsource platform, as shown in FIG. 2

As will be appreciated by those skilled in the relevant art(s) after reading the description herein, in such an aspect, an application service provider—an individual person, business, or other entity—may allow access, on a free registration, paid subscriber and/or pay-per-use basis, to infrastructure 101 via one or more World-Wide Web (WWW) sites on the Internet 112. Thus, system 100 is scalable.

As will also be appreciated by those skilled in the relevant art(s), in an aspect, various screens would be generated by web server 114 in response to input from users 102 over Internet 112. That is, in such an aspect, server 114 is a typical web server running a server application at a website which sends out webpages, while in communications with server 116, in response to Hypertext Transfer Protocol (HTTP) or Hypertext Transfer Protocol Secured (HTTPS) requests from remote browsers on computing devices being used by various crowdsourcers 102, representatives of crowdsourcers 102, employees of a crowdsourcer 102, organizations 104, and individuals 106. Thus, server 114 is able to provide a graphical user interface (GUI) in the form of webpages. These webpages are sent to the associated computing devices, and would result in the GUI being displayed.

In alternate aspects, application servers 116 (shown with associated storage in FIG. 1) may be configured to store various modules and data associated which facilitate crowdsourcing services, information, and the like. In alternate aspects, application servers 116 may comprise one or more data stores within (or remotely located from) infrastructure 101 or be a memory included in (or coupled to) web server(s) 110. That is, in alternate aspects, web servers 110 and application servers 116 may be located on the same physical machines as will be appreciated by those skilled in the relevant art(s) after reading the description herein.

As will be appreciated by those skilled in the relevant art(s) after reading the description herein, alternate aspects of the present disclosure may include providing a tool for facilitating aggregation and organization of crowdsource assets and providing effective crowdsourcer access to the crowdsource assets as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where one or more of crowdsourcer 102, organization 104, and individual 106 are all customers of the same entity (or affiliated entities), the present disclosure may be implemented as a stand-alone system, rather than as a web service (e.g., Application Service Provider (ASP) model utilized by various unassociated/unaffiliated entities) as shown in FIG. 1.

As will also be appreciated by those skilled in the relevant art(s) after reading the description herein, alternate aspects of the present disclosure may include providing the tools for facilitating aggregation and organization of crowdsource assets and providing effective crowdsourcer access to said crowdsource assets, a browser pre-installed with an applet or a browser with a separately downloaded applet on a computing device. That is, as will also be apparent to one skilled in the relevant art(s) after reading the description herein, an applet that facilitates the asset guarantee bond of the present disclosure disclosed herein may be part of the “standard” browser that ships with a computing device or may be later added to an existing browser as part of an “add-on,” or “plug-in,” or may be added as a separate mobile application software (app) capable of executing on a computing device after an “app store download.”

In one aspect, system 100 and its accompanying methods and computer program products of the present disclosure is configured to facilitate aggregation and organization of crowdsource assets and providing coordinated access between a crowdsourcer and crowdsource assets. Thus, the present disclosure is now described in more detail herein in terms of the above exemplary context. This is for convenience only and is not intended to limit the application of the present disclosure. In fact, after reading the following description, it will be apparent to one skilled in the relevant art(s) how to implement the following disclosure in alternative embodiments.

Referring now to FIG. 2, a data flow diagram of a network system 200 facilitating aggregation and organization of crowdsource assets 210, 212 and providing coordinated access between a crowdsourcer 102 and crowdsource assets 210, 212 is illustrated. Portions of data flow diagram may reside within system 100. As illustrated, a cloud may represent a pool of crowdsource assets 210, 212 or asset contributors 208, 206. The pool of asset contributors may comprise a pool of individual members 208 and a pool of organizational members 206. The pool of crowdsource assets may comprise a pool of resources 210 and a pool of solution providers 212. A crowdsourcer 102 may interface with the aggregating crowdsource platform 101 through a graphic user interface.

As an illustrative example, crowdsourcer 102 may describe itself as a start-up company that intends to manufacture a new type of bicycle frame for physically impaired children. Crowdsourcer 102 may initially become a member of the community network for monetary funding. Aggregating crowdsource platform 101 may suggest crowdsource assets 210, 212 not originally requested that may be useful to crowdsourcer 102. For example, a patent attorney may be suggested to protect the intellectual property for the bicycle frame. A bicycle seat and steering company may be suggested to collaborate to develop a complete bicycle or to share manufacturing resources.

Aggregating crowdsource platform 101 may also suggest that crowdsourcer 102 contribute certain crowdsource assets 210, 212 that may be mutually beneficial. For example, crowdsourcer 102 may be able to donate bicycles to a charity for children with physical impairments. The donation would benefit the charity, the recipients, and crowdsourcer 102, which may benefit from a charitable reputation and an opportunity to showcase its products.

Individuals 208 may contribute to crowdsource assets 210, 212 based on their capabilities, talents, and experience. Individuals 208 may register as members of community network. In some aspects, individuals 208 may describe contributable assets, whereas in others, aggregating crowdsource platform 101 may discern potential crowdsource assets from a completed profile, resume, or other experience-related information. Individuals 208 may be able to contribute, for example, expertise (e.g., as an advisor, mentor, board member, partner, employee, and the like), funding, or connections to nonmember crowdsource assets.

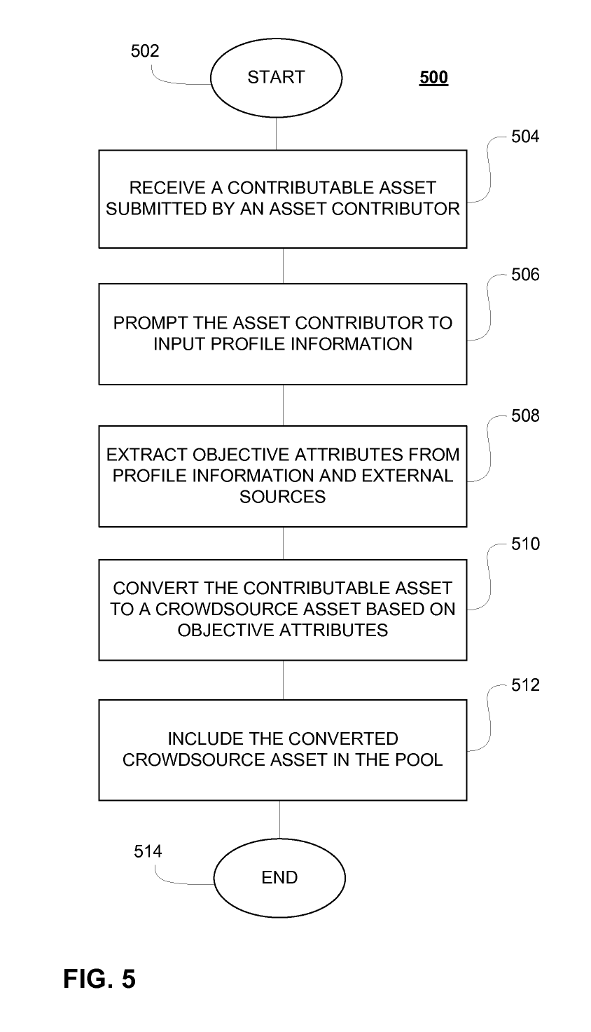

Similarly, organizations 206 may contribute to crowdsource assets 210, 212 based on their purpose, industry, and capabilities. A registered organization may complete a profile and describe contributable assets. In some aspects, aggregating crowdsource platform 101 may extract objective information from public documents or website, wherein the extracted information may be applied to modify the contributable assets into crowdsource assets 210, 212, such as illustrated in FIG. 5.

The contributable asset portfolios may allow crowdsourcer 102 to better assess the compatibility between their entities, which may allow crowdsourcer 102 to connect with the best asset contributor 208, 206 according to its needs, budget, and mission statement, in some aspects. For example, with the bicycle frame crowdsourcer illustration, one individual may be a patent attorney, one individual may be a habitual volunteer for the charity, and one individual may be a patent attorney who habitually volunteers. Crowdsourcer 102 may prefer the latter who may be able to provide at least two crowdsource assets. Similarly, one organization may be able to contribute $300,000 and has founded a charity for disabled children; one organization may be able to contribute $200,000 and grant access to its manufacturing plant; and one organization may be able to contribute $350,000 but is notorious for refusing to contribute to charitable foundations. Crowdsourcer 102 may prefer a lower monetary contribution in light of other contributable assets or other factors considered important to the crowdsourcer 102.

Crowdsourcer 102 may also be an asset contributor, which is indicated by the set of arrows between crowdsourcer 102 and aggregating crowdsource platform 101. In some aspects, crowdsourcer 102 may specifically define crowdsource assets it may be able or willing to contribute. In other aspects, aggregating crowdsource platform 101 may extrapolate potential crowdsource assets 210, 212 based on a crowdsourcer profile or requested crowdsource assets.

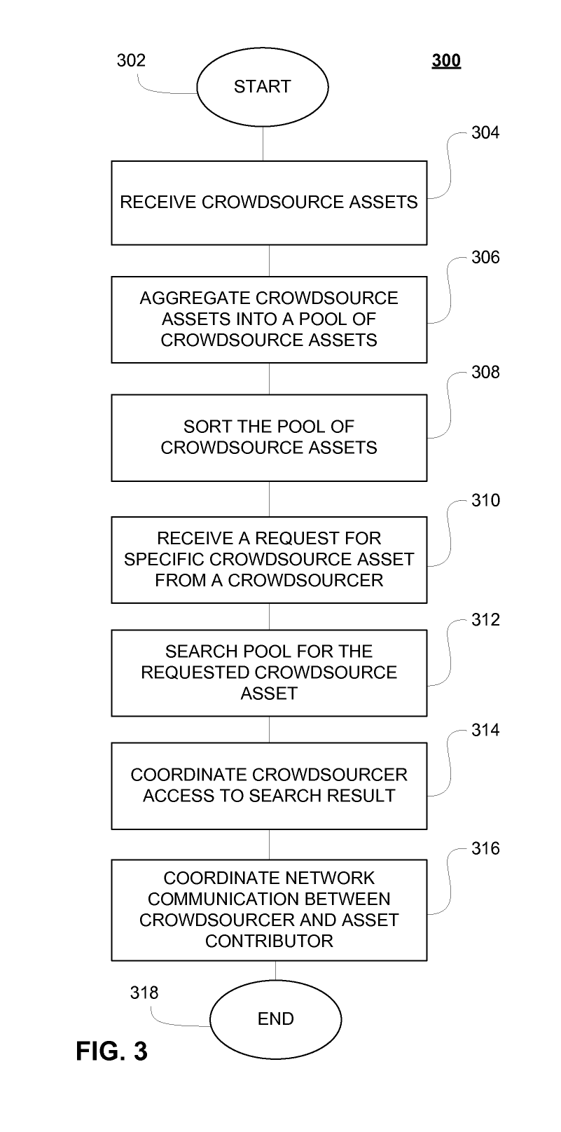

FIG. 3 is a flowchart illustrating an exemplary process 300 for facilitating aggregation and organization of crowdsource assets and providing coordinated access between crowdsourcer 102 and crowdsource assets, according to an aspect of the present disclosure. Process 300, which may execute within system 100, begins at step 302 with control passing immediately to step 304.

At step 304, infrastructure 101 receives a crowdsource asset. At step 306, infrastructure 101 aggregates received crowdsource assets (e.g., information about such assets) into a pool of crowdsource assets, wherein network community members may have access to the pool. At step 308, the pool of crowdsource assets may be sorted according to predefined categorization criteria. For example, as described in relation to FIG. 2, crowdsource assets 210, 212 may be separated into a pool of resources 210 and a pool of solution providers 212. In some aspects, network community members may configure the sorting criteria, which may allow them to more effectively search or browse through the pool of crowdsource assets. For example, a network community member may prefer to browse through the pool of crowdsource assets alphabetically or by asset contributor.

At step 310, a request for a specific crowdsource asset from crowdsourcer 102 may be received. At step 312, infrastructure 101 may search the pool for the specific crowdsource assets. In some aspects, the specific crowdsource asset may be simple, such as an exact amount of funding with no other framing criteria, and the search results may be a match to the each criteria of the specific crowdsource asset. In other aspects, the specific crowdsource asset may be more complex, and particular criteria may be searched in isolation. In such aspects, the search result may comprise crowdsource assets of varying degrees of relevance.

At step 314, infrastructure 101 may coordinate crowdsourcer access to search results, wherein the search results comprise a set of relevant crowdsource assets. In some aspects, at step 316, infrastructure 101 may further coordinate network communication between a crowdsourcer and an asset contributor associated with the relevant crowdsource assets. Process 300 then terminates at step 318.

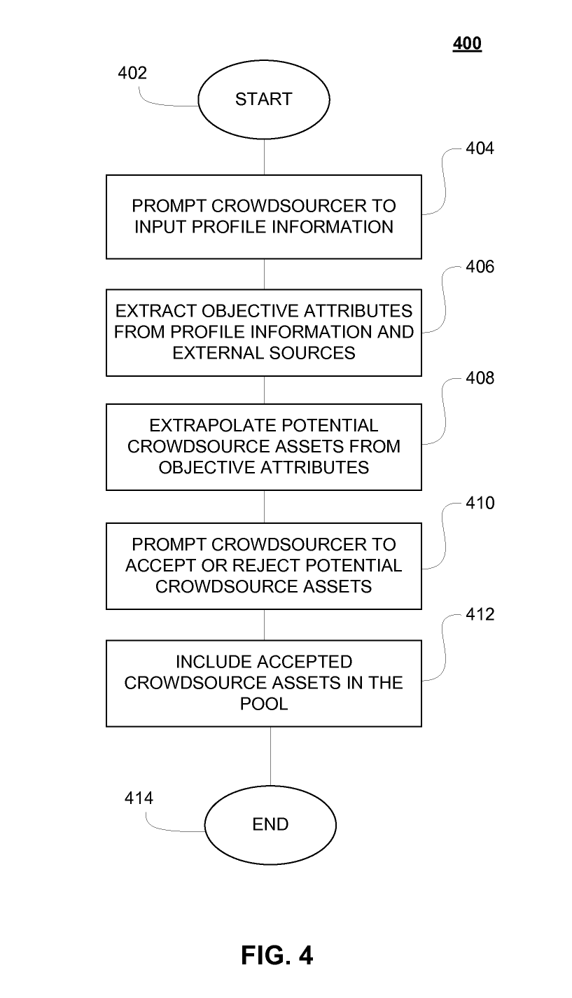

FIG. 4 is a flowchart illustrating an exemplary process 400 for facilitating identification of potential crowdsource assets from a crowdsourcer, according to an aspect of the present disclosure. Process 400, which may execute within system 100, begins at step 402 with control passing immediately to step 404. At step 404, infrastructure 101 prompts a crowdsourcer to input profile information. At step 406, objective attributes of crowdsourcer may be extracted from the profile information and external sources, such as described in relation to FIG. 2. At step 408, potential crowdsource assets may be extrapolated from the objective attributes extracted at step 406. At step 410, crowdsourcer is prompted to accept or reject potential crowdsource assets. At step 412, accepted crowdsource assets may be included in the pool of crowdsource assets. Process 400 then terminates at step 414.

FIG. 5 is a flowchart illustrating an exemplary process 500 for facilitating identification of crowdsource assets from asset contributor submitted contributable assets, according to an aspect of the present disclosure. Process 500, which may execute within system 100, begins at step 502 with control passing immediately to step 504. At step 504, infrastructure 101 receives a contributable asset submitted by an asset contributor, such as described in relation to FIG. 2. At step 506, the asset contributor may be prompted to input profile information. At step 508, objective attributes are extracted from the profile and external sources.

At step 510, infrastructure 101 converts contributable assets to crowdsource assets based on the objective attributes extracted at step 508. The conversion at step 510 may objectively verify, reject, or modify submitted contributable assets. Said conversion may not be necessary where infrastructure 101 extrapolates crowdsource assets directly from the objective attributes, such as at step 408 in FIG. 4. Coupling objective support to contributable assets may help reduce false crowdsource assets.

For example, an asset contributor may allege that they are a charitable organization and may offer $500,000 in contributable assets. At step 510, the contributable assets may be rejected where infrastructure confirms that the asset contributor is not registered as a charitable organization. In some aspects, infrastructure 101 may prompt the asset contributor to provide additional information that may refute negative conclusions.

At step 512, converted crowdsource assets may be included in the pool of crowdsource assets. Process 500 then terminates at step 514.

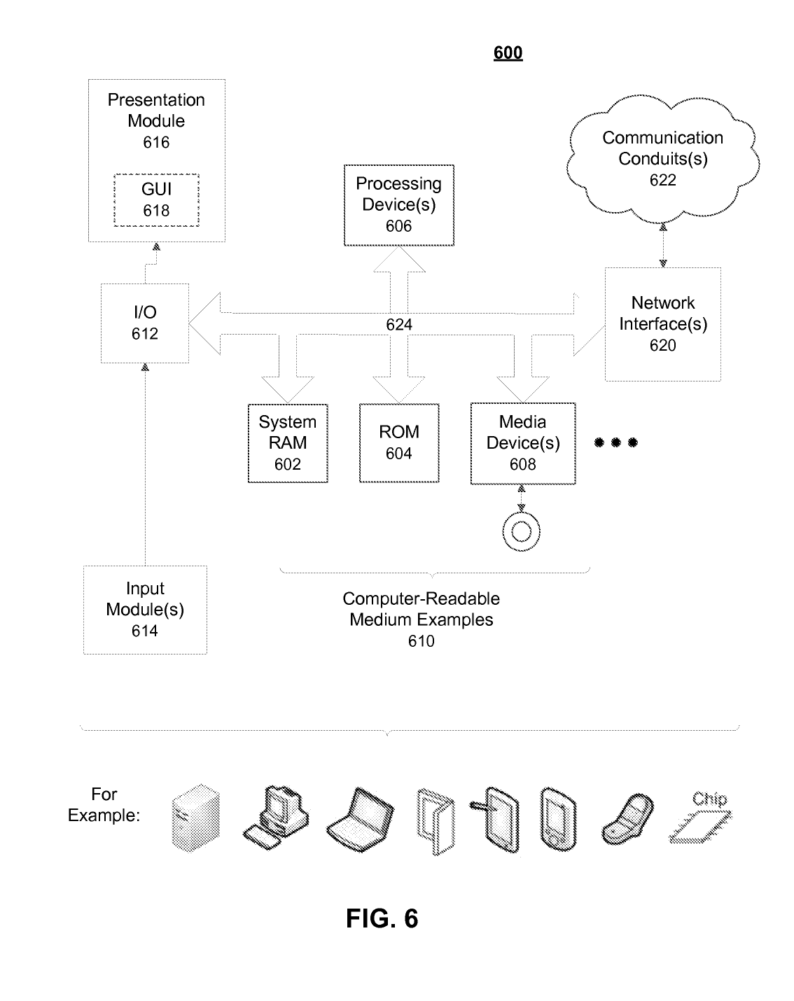

Referring now to FIG. 6, a block diagram of an exemplary computer system useful for implementing various aspects the processes disclosed herein, in accordance with one or more aspects of the present disclosure, is shown.

That is, FIG. 6 sets forth illustrative computing functionality 600 that may be used to implement aggregation and organization of crowdsource assets and provide effective crowdsourcer access to crowdsource assets and computing devices utilized by crowdsourcers and asset contributors (organizations and individuals) to, for example, access Internet 112, or any other component of system 100. In all cases, computing functionality 600 represents one or more physical and tangible processing mechanisms.

Computing functionality 600 may comprise volatile and non-volatile memory, such as RAM 602 and ROM 604, as well as one or more processing devices 606 (e.g., one or more central processing units (CPUs), one or more graphical processing units (GPUs), and the like). Computing functionality 600 also optionally comprises various media devices 608, such as a hard disk module, an optical disk module, and so forth. Computing functionality 600 may perform various operations identified above when the processing device(s) 606 executes instructions that are maintained by memory (e.g., RAM 602, ROM 604, and the like).

More generally, instructions and other information may be stored on any computer readable medium 610, including, but not limited to, static memory storage devices, magnetic storage devices, and optical storage devices. The term “computer readable medium” also encompasses plural storage devices. In all cases, computer readable medium 610 represents some form of physical and tangible entity. By way of example, and not limitation, computer readable medium 610 may comprise “computer storage media” and “communications media.”

“Computer storage media” comprises volatile and non-volatile, removable and non-removable media implemented in any method or technology for storage of information, such as computer readable instructions, data structures, program modules or other data. Computer storage media may be, for example, and not limitation, RAM 602, ROM 604, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 600 may also comprise an input/output module 612 for receiving various inputs (via input modules 614), and for providing various outputs (via one or more output modules). One particular output mechanism may be a presentation module 616 and an associated GUI 618. Computing functionality 600 may also include one or more network interfaces 620 for exchanging data with other devices via one or more communication conduits 622. In some aspects, one or more communication buses 624 communicatively couple the above-described components.

Communication conduit(s) 622 may be implemented in any manner (e.g., by a local area network, a wide area network (e.g., the Internet 112), and the like, or any combination thereof). Communication conduit(s) 622 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “service,” “module” and “component” as used herein generally represent software, firmware, hardware or combinations thereof. In the case of a software implementation, the service, module or component represents program code that performs specified tasks when executed on one or more processors. The program code may be stored in one or more computer readable memory devices, as described with reference to FIG. 6. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer-implemented method for facilitating aggregation and organization of crowdsource assets and providing coordinated access to crowdsource assets, the method comprising the steps of:
(a) receiving at least one crowdsource asset;
(b) aggregating the at least one crowdsource asset into a crowdsource assets pool stored in a crowdsource asset database accessible by a plurality of members;
(c) receiving, from a crowdsourcer, a request for a crowdsource asset, the crowdsource asset comprising a task coupled with a framing criteria, the crowdsourcer being one of the plurality of members;
(d) searching the crowdsource assets pool for the crowdsource asset, wherein the searching pulls a crowdsource asset results set according to the task and the framing criteria; and
(e) presenting to the crowdsourcer at least a portion of the set of crowdsource asset results.

2. The method of claim 1 further comprising the step of
(f) sorting the pool of crowdsource assets according to predefined categorization criteria.

3. The method of claim 2, wherein the sorting is configurable by the crowdsourcer.

4. The method of claim 2, wherein the predefined categorization criteria include additional crowdsource asset requests.

5. The method of claim 1, further comprising the steps of:
(f) receiving, from the crowdsourcer, crowdsourcer profile information;
(g) extracting at least one objective crowdsourcer attributes based on the received crowdsourcer profile information;
(h) extrapolating potential crowdsource assets based on the objective attributes;
(i) prompting the crowdsourcer to accept or reject potential crowdsource assets; and
(j) including accepted crowdsource assets in the set of crowdsource asset results.

6. The method of claim 1, further comprising the steps of:
(f) receiving at least one contributable asset from an asset contributor;
(g) prompting the asset contributor to input asset contributor profile information;
(h) extracting an objective attribute from the asset contributor profile;
(i) converting the at least one contributable asset to at least one converted crowdsource asset, wherein the conversion applies the objective attributes to modify the at least one contributable asset; and
(j) including the at least one converted crowdsource asset in the pool of crowdsource assets.

7. The method of claim 6, further comprising the step of:
(k) coordinating community network communication between the crowdsourcer and the asset contributor.

8. The method of claim 6, further comprising the step of:
(k) creating an asset contributor crowdsource asset portfolio, the asset contributor crowdsource asset portfolio comprising: at least one contributable asset and the objective attribute.

9. The method of claim 8, wherein the crowdsource asset portfolio is searchable by the crowdsourcer.

10. The method of claim 1, further comprising the step of:
(f) providing a rating for at least one of the set of crowdsource asset results.

11. The method of claim 10, wherein the rating is based on community feedback from at least a portion of the plurality of members.

12. The method of claim 10, wherein the rating is based on a member review of the at least one of the set of crowdsource asset results.

13. The method of claim 1, wherein the at least one crowdsource asset is an individual offer to be a board member.

14. The method of claim 1, wherein the at least one crowdsource asset is one of:
providing funding; supplying materials; volunteering time; providing equipment; providing accounting services; marketing; seeking employment; serving as an advisor; and serving as a board member.

15. One or more computer storage media having stored thereon multiple instructions that facilitate facilitating aggregation and organization of crowdsource assets and providing coordinated access to crowdsource assets, when executed by one or more processors of a computing device, causing the one or more processors to:
(a) receive at least one crowdsource asset;
(b) aggregate the at least one crowdsource asset into a crowdsource assets pool stored in a crowdsource asset database accessible by a plurality of members;
(c) receive, from a crowdsourcer, a request for a crowdsource asset, the crowdsource asset comprising a task coupled with a framing criteria, the crowdsourcer being one of the plurality of members;
(d) search the crowdsource assets pool for the crowdsource asset, wherein the searching pulls a crowdsource asset results set according to the task and the framing criteria; and
(e) present, via a GUI to the crowdsourcer, at least a portion of the set of crowdsource asset results.

16. One or more computer storage media as recited in claim 15, wherein the one or more processors are further caused to:
(f) sort the pool of crowdsource assets according to predefined categorization criteria.

17. One or more computer storage media as recited in claim 15, wherein the sorting is configurable by the crowdsourcer.

18. One or more computer storage media as recited in claim 15, wherein the predefined categorization criteria include additional crowdsource asset requests.

19. One or more computer storage media as recited in claim 15, wherein the one or more processors are further caused to:
(f) receive, from the crowdsourcer, crowdsourcer profile information;
(g) extract at least one objective crowdsourcer attributes based on the received crowdsourcer profile information;
(h) extrapolate potential crowdsource assets based on the objective attributes;
(i) prompt the crowdsourcer to accept or reject potential crowdsource assets; and
(j) include accepted crowdsource assets in the set of crowdsource asset results.

20. One or more computer storage media as recited in claim 15, wherein the one or more processors are further caused to:
(f) receive at least one contributable asset from an asset contributor;
(g) prompt the asset contributor to input asset contributor profile information;
(h) extract an objective attribute from the asset contributor profile;
(i) convert the at least one contributable asset to at least one converted crowdsource asset, wherein the conversion applies the objective attributes to modify the at least one contributable asset; and
(j) include the at least one converted crowdsource asset in the pool of crowdsource assets.

21. One or more computer storage media as recited in claim 15, wherein the one or more processors are further caused to:
(k) coordinate community network communication between the crowdsourcer and the asset contributor.

22. One or more computer storage media as recited in claim 15, wherein the one or more processors are further caused to:
(k) create an asset contributor crowdsource asset portfolio, the asset contributor crowdsource asset portfolio comprising: at least one contributable asset and the objective attribute.

23. One or more computer storage media as recited in claim 22, wherein the crowdsource asset portfolio is searchable by the crowdsourcer.

24. One or more computer storage media as recited in claim 15, wherein the one or more processors are further caused to:
(f) provide a rating for at least one of the set of crowdsource asset results.

25. One or more computer storage media as recited in claim 24, wherein the rating is based on community feedback from at least a portion of the plurality of members.

26. One or more computer storage media as recited in claim 24, wherein the rating is based on a member review of the at least one of the set of crowdsource asset results.

27. One or more computer storage media as recited in claim 15, wherein the at least one crowdsource asset is an individual offer to be a board member.

28. One or more computer storage media as recited in claim 15, wherein the at least one crowdsource asset is one of: providing funding; supplying materials; volunteering time; providing equipment; providing accounting services; marketing; seeking employment; serving as an advisor; and serving as a board member.

29. A system for facilitating aggregation and organization of crowdsource assets and providing coordinated access between a crowdsourcer and crowdsource assets, comprising:
(a) at least one web server capable of providing a graphical user interface, via a communications network, to a plurality of computing devices, the plurality of computing devices configured to communicate with at least one of: a crowdsourcer, an organization, and an asset contributor; and
(b) at least one application server, communicatively coupled to the at least one web server via the communications network, the at least one application server comprising:
(i) a crowdsource asset aggregating service capable of:
receiving at least one crowdsource asset; and
aggregating the at least one crowdsource asset into a pool of crowdsource assets stored in a community network system accessible by members of a community network comprising a pool of at least one member;
(ii) a crowdsource asset coordinating service capable of:
receiving a request for a first crowdsource asset from a crowdsourcer, wherein the first crowdsource asset comprises a task coupled with framing criteria;
searching the pool of crowdsource assets for the first crowdsource asset, wherein the searching pulls a set of crowdsource asset results according to the task and the framing criteria; and
coordinating crowdsourcer access to the set of crowdsource asset results through the community network.

30. The system as recited in claim 29, wherein the at least one application server further comprises:
(iii) a contributable asset submission service capable of:
receiving at least one contributable asset submitted by an asset contributor;
prompting the asset contributor to input profile information about the asset contributor;
extracting objective attributes from the asset contributor profile;
converting the at least one contributable asset to at least one converted crowdsource asset, wherein the conversion applies the objective attributes to modify the at least one contributable asset;
including the at least one converted crowdsource asset in the pool of crowdsource assets.
